(19) United States
(12) Patent Application Publication
(10) Pub. No.: US 2006/0256227 A1
(43) Pub. Date: Nov. 16, 2006

(54) Digital camera device and method for producing the same

(76) Inventor: Heinrich Gotzig, Heilbronn (DE)

Correspondence Address: DREISS, FUHLENDORF, STEIMLE & BECKER, POSTFACH 10 37 62, D-70032 STUTTGART, DE

(21) Appl. No.: 10/556,503

(22) PCT Filed: Apr. 23, 2004
(86) PCT No.: PCT/EP04/04303

§ 371 Date: Nov. 14, 2005

(30) Foreign Application Priority Data
May 16, 2003 (DE) 102 23 672.4

(51) Int. Cl. G02B 13/16

(52) U.S. Cl. 348/335

(57) ABSTRACT

The invention relates to a digital camera device for identifying an object, and to a method and a computer program for producing the same. According to prior art, digital camera devices comprising an objective, a light sensor and an image producing device are known. It is also known that the recorded images have a distortion effect that depends on the focal length of the objective, said distortion effect until now being corrected by calculation in the image producing device during processing of the image. The claim of the invention is to render one such calculated correction superfluous. Towards this end, the density of pixel elements is determined according to the focal length of the objective for the flat arrangement of said pixel elements in the light sensor device.

The invention concerns a digital camera device as well as a method and a computer program for its production.

Digital camera devices are known in the art for recording an object which may be located in the environment of a vehicle. These types of camera devices usually include a lens device for the acceptance and further passage of light representing the object. These devices also have a light sensor device comprising a plurality of pixel elements distributed in flat orientation, with the pixel elements being evenly distributed within the flat area, e.g. their density is constant throughout the area of the light sensor device. Each pixel element produces a signal which represents the intensity of the light passed from the lens device onto the corresponding pixel element. The camera device also includes an imaging device for the production of an image signal from the plurality of pixel signals, which represents the recorded object.

When a camera device of this type is utilized for the examination of the environment of the vehicle it is usually configured in such a way as to image as wide a field of view as possible. This wide field of view is usually realized by configuring the lens device with a very short focal length. The short focal length, however, has the disadvantage of associated distortion effects (so-called fish-eye effect). The distortions in the image of a recorded object caused by these effect increase with decreasing focal length.

These distortion effects are conventionally corrected by software in the imaging device of the digital camera device.

Departing from this prior art, it is the purpose of the present invention to further improve a conventional camera device and a method as well as a computer program for its production in such a fashion that correction of the distortion effects is at least substantially avoided.

This purpose is achieved with the camera device in accordance with claim 1. The object the invention is achieved for the above described camera device in that the density of the pixel elements in the flat arrangement of the light sensor device is determined in dependence on the focal length of the lens device.

“Density of pixel elements” within the sense of the current invention refers to the number of pixel elements per unit area.

### ADVANTAGES OF THE INVENTION

The proposed determination of the density of the pixel elements in the flat disposition of the sensor device advantageously permits correction of the distortion of imaging information caused by the lens device. This hardware correction obviates the need for software corrections (calculated corrections) in the imaging device during image processing.

Advantageously, not only the density but also its distribution in the flat configuration is optimized to correct for the distortions. Towards this end not only the focal length but also the geometric shape and index of refraction of the lens device are advantageously taken into consideration.

The claimed digital camera device is advantageously at least partially configured as a complementary symmetry metal oxide semi-conductor CMOS or as a charged couple device CCD imaging chip.

The above mentioned purpose of the invention is also achieved by a method and by a computer program for the production of a digital camera device and, in particular, a light sensor device.

In carrying out that method, regions of the flat light sensor device having highest pixel density are advantageously initially calculated and produced and regions having lower pixel density are subsequently calculated and produced. This simplifies production of the chips.

The method and the computer program also share the advantages mentioned above with respect to the digital camera device.

### DRAWINGS

FIG. 1 shows the structure of a digital camera device;

FIG. 2 is a first embodiment of a configuration of the light sensor device in accordance with the invention; and

FIG. 3 is a second embodiment of a configuration of the light sensor device in accordance with the invention.

The invention as described in detail below using two embodiments with reference to the accompanying drawings.

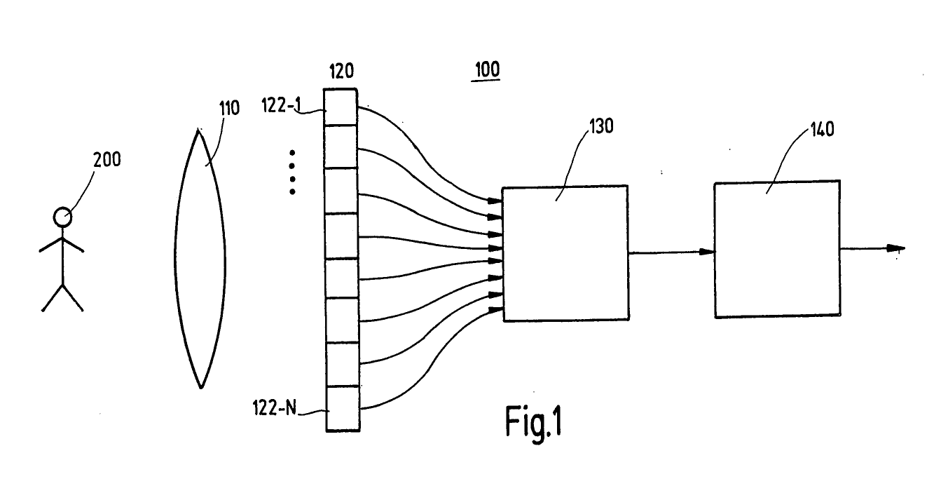

FIG. 1 shows the basic construction of a digital camera device 100. The camera device 100 serves to recognize an object 200, in particular in the environment of the vehicle. Towards this end, the device comprises a lens device 110 for the acceptance and further passage of light representing the object 200. The lens device 110 is, in the simplest case, a single lens. Light passed through the lens device 110 is incident on a light sensor device 120 comprising a plurality of pixel elements 122-1 . . . -N, disposed in flat arrangement. When activated, each of these pixel elements, produces a pixel signal which represents the intensity of the light incident on the corresponding pixel element. The pixel signals are received by an imaging device 130 disposed downstream of the light sensor 120 and processed to produce an image signal from a plurality of pixel signals which represents the recorded object 200. The imaging signal is preferentially stored in a storage device 140 associated with the camera device 100.

In accordance with the invention, the light sensor device 120 is configured in such a fashion that the density of its pixel elements is determined in dependence on the focal length of the lens device 110. In particular, the density of the pixel elements is lower for smaller focal lengths than for larger focal lengths, and vice versa.

In addition to the focal length, the geometrical shape of the lens device or its index of refraction should also be taken into consideration when optimizing the distribution of the density of pixel elements throughout the flat surface.

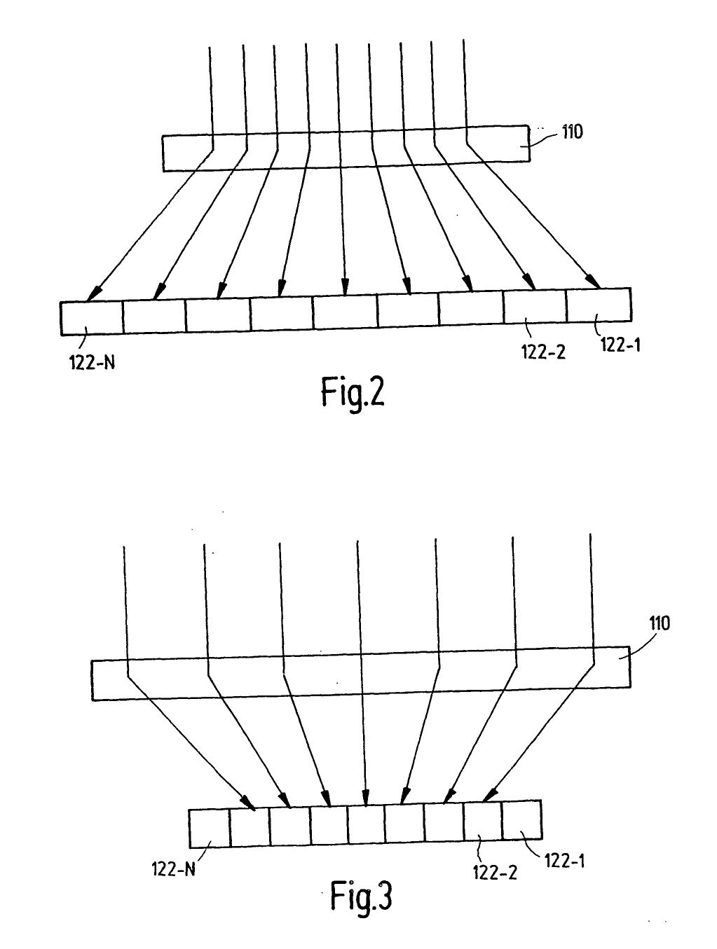

FIG. 2 shows a first embodiment for configuration of the light sensor device 120 in accordance with the invention and, in particular, its pixel distribution. The device has a convex lens device 110 by means of which the light rays passed on to the pixel elements 120-1 . . . -N diverge. In a lens device of this type 110, distortion effects occur as the image is expanded. In accordance with the invention, the separation between neighboring pixel elements 120-1 . . . -N is increased in correspondence with the expansion, e.g. the density of pixel elements is accordingly reduced.

FIG. 3 shows a second embodiment for the light sensor device 120 in accordance with the invention. In the event that the lens device 110 is concave the light ray incident on the pixel elements 122-1 . . . -N converges. Distortion effects are thereby produced as the image of the object 200 on the pixel elements is compressed. In this case, the separation between the pixel elements 122-1- . . . -N is reduced in correspondence with the compression, e.g. the density of the pixel elements is increased accordingly.

1-7. (canceled)

8. A digital camera device for detecting an object, in particular in the environment of a vehicle, the device comprising:
a lens member for the acceptance and further passage of light representing the object;
a light sensor member having a plurality of pixel elements disposed in flat arrangement, wherein each pixel element produces a pixel signal which represents an intensity of light transported from said lens member onto that pixel element, wherein a density of said pixel elements within said light sensor member is distributed in dependence on a geometric shape or an index of refraction of said lens member; and
an imaging member for production of an image signal from a plurality of pixel signals representing a recorded object.

9. The digital camera device of claim 8, wherein said density of pixel elements is defined in dependence on a focal length of said lens member.

10. The digital camera device of claim 8, wherein said camera device is at least partially configured as a CMOS or CD imaging chip.

11. A method for production of a digital camera device having a lens member and a light sensor member disposed downstream of the lens member and having a plurality of pixel elements in flat arrangement, the method comprising the following steps:
a) determining a density distribution of the pixel elements in dependence on a geometric shape or an index of refraction of the lens member;
b) initially manufacturing pixels in a region of high pixel density; and
c) subsequently producing regions having lower pixel density.

12. The method of claim 11, wherein the density distribution of the pixel elements is defined by a focal length of the lens member.

13. A computer program having a program code configured to calculate the distribution of the density of pixel elements for the light sensor member according to the method of 11.
